(19) United States
(12) Patent Application Publication
(10) Pub. No.: US 2013/0018612 A1
(43) Pub. Date: Jan. 17, 2013

(54) DEVICE AND METHOD FOR OBSERVING OR CONTROLLING A NON-LINEAR SYSTEM

(71) Applicants: Mathieu Grossard, Montrouge (FR); Mehdi Boukallel, Paris (FR)

(72) Inventors: Mathieu Grossard, Montrouge (FR); Mehdi Boukallel, Paris (FR)

(73) Assignee: COMMISSARIAT A L'ENERGIE ATOMIQUE ET AUX ENERGIES ALTERNATIVES, PARIS (FR)

(21) Appl. No.: 13/638,834

(22) PCT Filed: Apr. 11, 2011
(86) PCT No.: PCT/FR11/50814

§ 371 Date: Oct. 1, 2012

(30) Foreign Application Priority Data
Apr. 14, 2010 (FR) 1052854

(51) Int. Cl. G06F 19/00

(52) U.S. Cl. 702/65

(57) ABSTRACT

An observation device of a non-linear system includes: at least one sensor supplying a measurement vector each component of which is a measurable output parameter of the non-linear system; and a state observer processor that, based on a predetermined state representation of the non-linear system, is configured to supply an estimation of a state vector of the non-linear system according to the measurement vector supplied and a control vector of the non-linear system. In addition, the predetermined state representation including a non-linearity model of the system in a form of a gain parameter, and one component of the state vector is this gain parameter.

The present invention concerns a device for observing a non-linear system. It also concerns a control system including such an observation device, a corresponding method and application thereof to the observation of a non-linear system of the Hammerstein type.

“Non-linear system” means a system that responds dynamically, but not according to a linear model, to a control. This control takes the form of a set of parameters transmitted to the system, which then constitute the components of a control vector. When this control can be supplied by a processor sending electrical signals, the system is an automatic controller.

The non-linear behavior of the system makes a state representation of this system more difficult to establish. Such a state representation must however make it possible to know the state of the system at any future instant if the values of an initial state of the system and the control are known. The non-linearity of the system consequently makes control thereof more complex. In particular, the difficulty or impossibility of precisely modeling a non-linear system by a state representation may give rise to a bias between the expected result of a control and the actual resulting state of the system.

One solution therefore consists of estimating this bias in order optionally to correct it, by means of sensors making it possible to measure the state of the system at any moment.

However, the state of a system is not always directly measurable. On the basis of a state representation, it is then possible to define by extension a state observer that makes it possible all the same to estimate the state of the system from the state representation, the control vector and a measurement vector, each component of which is a measurable output parameter of the system. This is why a state observer is also called the “software sensor” of the system.

The invention thus applies more particularly to a device for observing a non-linear system, comprising:
at least one sensor for supplying a measurement vector each component of which is a measurable output parameter of the non-linear system,
a state observer processor, based on a predetermined state representation of the non-linear system, designed to supply an estimation of a state vector of the non-linear system according to the measurement vector supplied and a control vector of the non-linear system.

In particular, however, non-linear systems having a non-linearity of the hysteresis type are particularly difficult to model by a state representation. More precisely, systems of the Hammerstein type, that is to say systems able to be represented by a non-linear part, representing the statics of the system, functionally in series with a linear part representing the dynamics of the system, are difficult to model, and even more so those wherein the static non-linearity is of the hysteresis type.

Because of the presence of this static non-linearity of the hysteresis type, monitoring such a system by known techniques is a difficult task in practice. The majority of existing solutions do not take account of the hysteresis phenomenon. This leads to degraded performances of the control. However, solutions taking account of this phenomenon exist: some for a control of the system in open loop (control without correction by a control law), others for closed-loop control (control driven by a control law governed using measurements or estimations issuing from sensors).

For example, digital modeling techniques, such as the Preisach model, make it possible to describe the hysteretic static non-linearity, as described in the article by P. Ge et al., entitled “Generalized Preisach Model for Hysteresis Nonlinearity of Piezoceramic Actuators”, Precision Engineering, vol. 20, pages 99-111, 1997. They can then be associated with an open-loop control method that consists of, by inversion of the model, compensating for the non-linearity phenomena. However, these models are generally complex and difficult to use for applications with real-time constraints.

More recently, it was demonstrated in the article by U. X. Tan et al., entitled “Modeling Piezoelectric Actuator Hysteresis with Singularity Free Prandtl-Ishlinskii Model”, Proceedings of the IEEE International Conference on Robotics and Biomimetics, pages 251-256, December 2006, Kunming (China), that the Prandtl-Ishlinskii operator, less complex than the Preisach model, has the advantage of having an analytical inverse that is easier to calculate. This operator is better suited to a real-time implementation, for which the computing time is always critical. However, as with the majority of other models, some numerical cases that correspond to the singularities of the hysteresis curve prevent the mathematical existence of the inverse operator, or sometimes lead to poor numerical conditionings.

Hysteresis may also be taken into account by a generalized Maxwell model, through a set of differential equations describing the hysteresis curve (Bouc-Wen model, for example), by polynomial or iterative approaches, using neural network learning techniques, etc. However, all these models or techniques always have a certain complexity and, in a more general context where the conditions of use are changing, the empirical estimation of parametric variables of these models requires increasing the identification protocols (that is to say forms, amplitudes, signal frequencies), without which the model becomes unsuitable.

In general terms, an issue of precision of the model with respect to the reality of hysteresis is always raised.

Finally, each of these models or techniques may also be used, for a closed-loop control, in the feedback loop in order to be taken into account in the control law by a control corrector. However, despite any recourse to model reduction methods, the latter advanced closed-loop control techniques may however lead to the obtaining of a corrector of high order, which does not in the long term facilitate their implementation in a controller with real-time constraints.

It may thus be desired to provide an observation device that makes it possible to dispense with at least some of the aforementioned problems and constraints.

A subject matter of the invention is therefore a device for observing a non-linear system, comprising:
at least one sensor for supplying a measurement vector each component of which is a measurable output parameter of the non-linear system,
a state observer processor, based on a predetermined state representation of the non-linear system, designed to supply an estimation of a state vector of the non-linear system according to the measurement vector supplied and a control vector of the non-linear system,
   wherein, the predetermined state representation comprising a non-linearity model of the system in the form of a gain parameter, one component of the state vector is the gain parameter.

Thus, the state observer processor being designed to provide an estimation of the change in the state vector over time, by virtue of the invention, it also becomes able to supply an estimation of the temporal change in the gain parameter that is integrated in the state representation as a parametric model of the static non-linearity. This is because static non-linearity may cleverly be simply seen at each instant as a static gain, the latter changing moreover non-linearly over time. Consequently, rather than a priori establishing a complex and approximate global model of this non-linearity, the invention proposes to observe at each instant the corresponding gain parameter, that is to say the instantaneous effect of this non-linearity on the system. Since this model is simple, it allows observation and therefore monitoring of the non-linearity in real time.

Optionally, the state observer process is based on a state representation comprising a non-linear part modeled by the gain parameter representing the statics of the non-linear system, and a linear part modeled by a predetermined transfer function.

Optionally also, the state observer processor is an extended Kalman filter.

Another subject matter of the invention is a system for controlling a non-linear system, comprising:
an observation device as defined previously, and
a corrector of the control vector based on a control law comprising a gain adjusted over time as a function of the values taken by the gain parameter of the state vector.

Optionally, the corrector is of the variable-gain PID type.

Optionally also, the variable-gain PID corrector comprises a proportional gain defined as inversely proportional to the gain parameter of the state vector.

Another subject matter of the invention is a method for observing a non-linear system comprising the following steps:
reception, by a state observer processor based on a predetermined state representation of the non-linear system, of a measurement vector each component of which is a measurable output parameter of the non-linear system,
estimation, by the state observer processor, of a state vector of the non-linear system as a function of the measurement vector supplied and a control vector of the non-linear system,
   wherein, the predetermined state representation comprising a model of non-linearity of the system in the form of a gain parameter, the estimation of the state vector comprises an estimation of the gain parameter as a component of the state vector.

Another subject matter of the invention is a method for controlling a non-linear system comprising the steps of an observation method as defined previously and a step of updating, by means of a control corrector based on a control law of the non-linear system, of a gain of this control corrector as a function of the values taken by the gain parameter of the state vector over time.

Another subject matter of the invention is the application of an observation or control method as defined previously to the observation or control of a non-linear system of the static hysteresis Hammerstein type, in particular a piezoelectric microactuator or a robotic articulation with transmission by manipulator arm cable.

Finally, another subject matter of the invention is a computer program downloadable from a communication network and/or recorded on a medium that can be read by computer and/or executed by a processor, comprising instructions for executing the steps of an observation or control method as defined previously, when said program is executed on a computer.

The invention will be better understood by means of the following description, given solely by way of example and made with reference to the accompanying drawings, in which:

FIG. 1 shows schematically the general structure of a system for controlling a non-linear system, according to one embodiment of the invention,

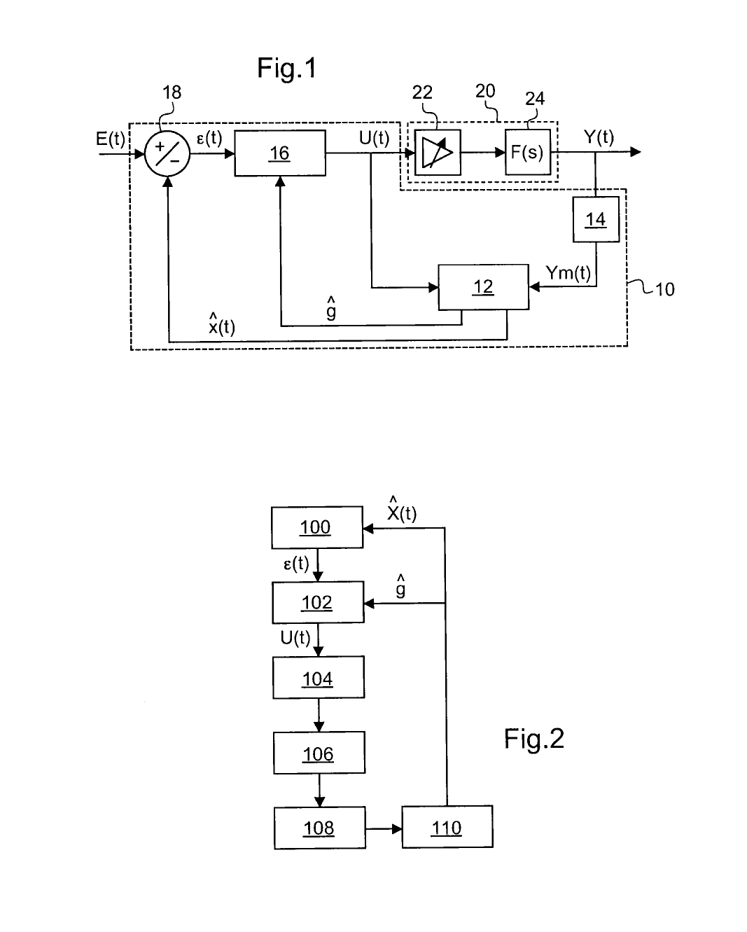

FIG. 2 illustrates the successive steps of an observation and control method implemented by the system of FIG. 1,

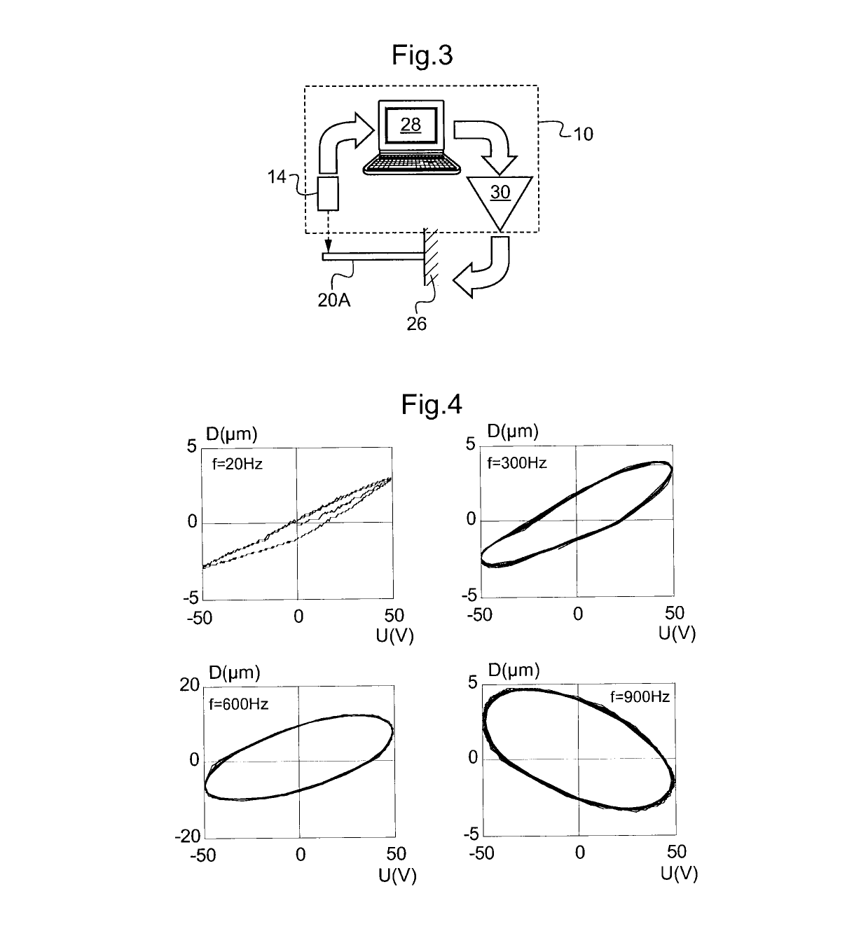

FIG. 3 illustrates the use of the system of FIG. 1 for controlling a piezoelectric microactuator,

FIG. 4 illustrates by means of diagrams an example of dependency of the static non-linearity of the piezoelectric microactuator of FIG. 3 according to the frequency of exciting signals,

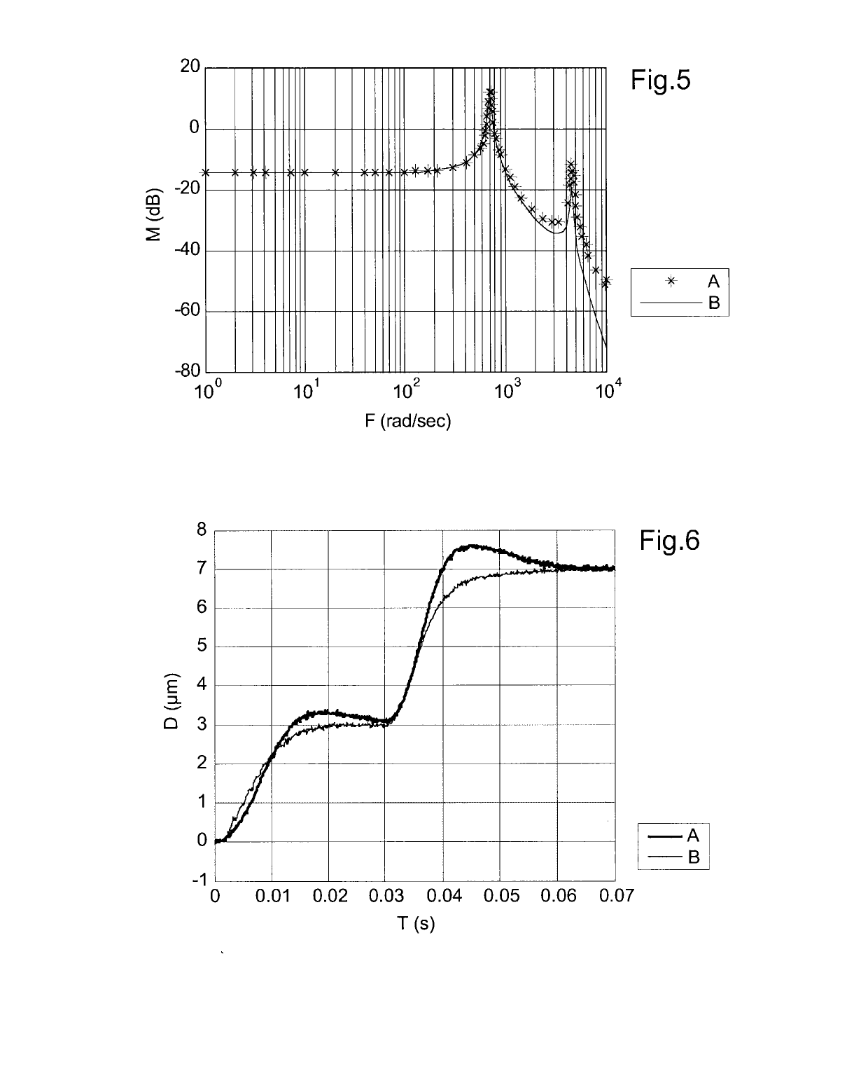

FIG. 5 illustrates an example of a Bode diagram of a transfer function able to model the dynamic linearity of the piezoelectric microactuator of FIG. 3,

FIG. 6 illustrates by diagram a comparison of the performances of a control system according to the invention compared with a conventional control system in the use of FIG. 3,

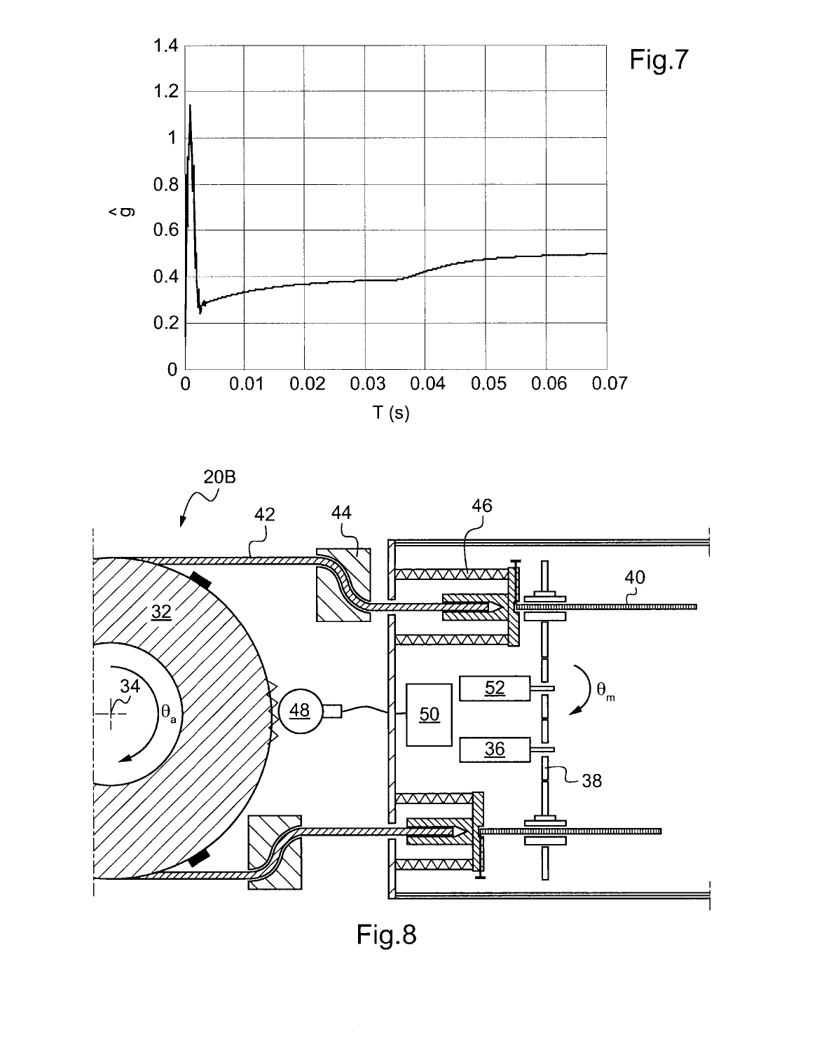

FIG. 7 illustrates by diagram the variations observed in a gain parameter modeling the static non-linearity of the piezoelectric microactuator of FIG. 3 by means of the implementation of an observation method according to the invention, and

FIG. 8 illustrates the use of the system of FIG. 1 for controlling a robotic articulation with transmission by manipulator arm cable.

The control system 10 shown schematically in FIG. 1 comprises an observation device 12, 14, the latter comprising conventional software means (processor, read only and/or random access memories, digital data transmission bus, etc.) implementing a state observer processor 12 and at least one sensor 14 for supplying at least one measured parameter Ym(t) to the state observer processor 12. It also comprises a control vector corrector 16 based on a control law and an input/output comparator 18 for supplying a slaving signal ε(t) to the corrector 16.

This control system 10 is connected to a non-linear system 20. In the remainder of the description, it is assumed that the non-linear system 20 is of the Hammerstein type, that is to say its reaction to a control can be modeled by a non-linear part 22, representing the statics of the system, functionally in series with a linear part 24 representing the dynamics of the system.

More precisely, the control system 10 is designed so that its corrector 16 transmits a control vector U(t) at the input of the non-linear system 20. This transmission is for example electrical, the component or components of the control vector U(t) being composed of one or more electrical signals exciting the system 20.

In reaction to the excitation transmitted by the control vector U(t), the non-linear system 20 reacts statically and dynamically and its state changes. The sensor 14 of the control system 10 is then designed and placed so as to measure at least one output parameter of the non-linear system. In vectorial representation, the sensor 14 is placed at a measurable output Y(t) of the non-linear system 20 in order thus to supply a measurement vector Ym(t) each component of which is the measured value of a measurable output parameter of the non-linear system 20.

A modeling of the non-linear system 20 and of the change in its state can be achieved on the basis of a predetermined state representation, in which the state of the non-linear system takes the form of a state vector X(t). As will be detailed hereinafter, according to the invention, the state vector X(t) defined so as to represent the state of the system 20 comprises, as a component, a gain parameter g modeling the static non-linear part 22. This gain parameter g is not directly measurable as an output but can be estimated, via an estimation of the state vector X(t), by virtue of the implementation of a software sensor that constitutes the state observer processor 12.

To this end, the state observer processor 12 receives as an input the measurement vector Ym(t) issuing from the sensor 14 and the control vector U(t) issuing from the corrector 16 and, on the basis of the predetermined state representation of the non-linear system 20, supplies an estimation \hat{X}(t) of the state vector X(t). The functioning of the state observer processor 12 will be detailed subsequently, on the basis of a non-limitative example of a state observer generally used, of the extended Kalman filter type.

To allow closed-loop functioning of the control system 10, the estimation \hat{X}(t) supplied by the state observer processor 12 is transmitted to the input/output comparator 18, which concretely compares the estimated value of at least some of the components of the state vector X(t) with a set value signal E(t) to supply the slaving signal ε(t) to the corrector 16. In addition, according to the invention, the values ĝ estimated over the course of time by the state observer processor 12 of the gain parameter g are supplied to the corrector 16, wherein the control law on which it is based comprises a gain regulated over the course of time as a function of these values.

The modeling of the non-linear system 20 and the establishment of its state representation will now be detailed.

According to this modeling, and as indicated previously, a gain parameter g is integrated in the state representation as a parametric model of the static non-linearity of the system 20. This is because, as from the moment when the non-linear system 20 can be considered to exhibit a static non-linearity and a dynamic linearity that are separable, which is in particular the case when it is of the Hammerstein type, including when its static non-linearity is of the hysteresis type, the non-linearity may cleverly be seen at each instant as a static gain, the gain moreover changing in a non-linear fashion over time. The dynamics of the system 20, which is linear, can then be represented independently of its statics by a transfer function F(s) in Laplace coordinates, that is to say the Laplace transform of the linear differential equation that represents the linear part between the input and output of the system. For reasons of simplicity in the remainder of the description, the order of this transfer function F(s) is fixed arbitrarily at two. A higher order could be envisaged, but this would unnecessarily burden the calculations represented below. The following model for the linear part 24 of the system 20 is then obtained:

$$F ( s ) = \frac{1}{\frac{1}{{w}_{n}^{2}} {s}^{2} + \frac{2 ξ}{{w}_{n}} s + 1} ,$$

where wₙ and ξ represent respectively the natural angular frequency and the damping of the system 20.

By choosing to treat the static non-linearity, in particular the hysteresis, as a simple static gain g liable to vary over time, the non-linear system 20 finally amounts to a linearly modeled system resulting from putting the variable static gain g and the transfer function F(s) in series. The transfer function of the complete system 20 between the control u(s) and the measurable output y(s) is then written:

$$\frac{y ( s )}{u ( s )} = \frac{g}{\frac{1}{{w}_{n}^{2}} {s}^{2} + \frac{2 ξ}{{w}_{n}} s + 1} .$$

For reasons of simplicity again, it is assumed that the measurable output Y(t) of the system comprises in fact solely one position parameter x that is also a component of the state vector X(t), the latter also comprising the time derivative of this position x and the gain parameter g. More measurable parameters and/or components could be envisaged (for example an acceleration component) but this would unnecessarily burden the calculations presented below.

In state representation, that is to say in matrix form, the system 20 can then be defined by the following equation:

$$[ \begin{matrix}\dot{x} \\ \ddot{x} \\ g\end{matrix} ] = [ \begin{matrix}0 & 1 & 0 \\ - {w}_{n}^{2} & - 2 ξ {w}_{n} & {w}_{n}^{2} u \\ 0 & 0 & 0\end{matrix} ] [ \begin{matrix}x \\ \dot{x} \\ g\end{matrix} ] ,$$

that is to say \dot{X}=AX, where X is the state vector and A the state representation matrix of the system 20.

This equation defines the time change of the system. It is not linear since it involves the control u in the matrix A.

The state observer processor 12, when it is of the extended Kalman filter type, can then be based on this state representation and defined by the following state observation model:

$$x = [ \begin{matrix}1 & 0 & 0\end{matrix} ] [ \begin{matrix}x \\ \dot{x} \\ g\end{matrix} ] ,$$

that is to say Y=CX, where Y is the measurement vector (here the position x) and C the observation matrix. This equation defines the observation of the output of the system 20.

In order to be able to be implemented in the state observer processor 12, this model of system 20 requires to be discretized. For this purpose, the following bilinear Tustin transformation is for example used:

$$s = \frac{2}{{T}_{e}} \frac{z - 1}{z + 1} ,$$

in which s designates the Laplace variable and z the Z transform of the sampled system. Tₑ moreover designates the sampling period of the system.

After computation (not detailed since it is conventional), the discrete form of the representation and state observation is written:

Xₖ₊₁=Fₖ₊₁(uₖ,uₖ₊₁)Xₖ,

Yₖ₊₁=Hₖ₊₁Xₖ where

$${F}_{k + 1} = {( {I}_{3 \times 3} - \frac{{T}_{e}}{2} [ \begin{matrix}0 & 1 & 0 \\ - {w}_{n}^{2} & - 2 ξ {w}_{n} & {w}_{n}^{2} {u}_{k + 1} \\ 0 & 0 & 0\end{matrix} ] )}^{- 1} \cdot ( {I}_{3 \times 3} + \frac{{T}_{e}}{2} [ \begin{matrix}0 & 1 & 0 \\ - {w}_{n}^{2} & - 2 ξ {w}_{n} & {w}_{n}^{2} {u}_{k} \\ 0 & 0 & 0\end{matrix} ] ) ,$$

and

Hₖ₊₁=[1 0 0].

These discrete recurrence equations make it possible to model the change in the state of the system at step (k+1) knowing the state at step k and describing the fact that the output Yₖ₊₁ is none other than the position x at step k.

Once the modeling in discrete form is established, the extended Kalman observer is implemented in the processor 12 in order to estimate the state X(t) at each time step. However, the static non-linearity, for example the static hysteresis, of the system 20 being present in the form of the gain g in the state, it is then possible to estimate the change in the static gain g in the course of time by means of this observer.

The principle of extended Kalman filtering, which moreover forms part of the general knowledge of a person skilled in the art, is briefly stated below.

On the basis of the model previously defined, by denoting the state noise vector on the interval of time [tₖ, tₖ₊₁], white, Gaussian, of zero mean and covariance matrix Qₖ=E[wₖ, wₖ^{T}] as wₖ, and also denoting the measurement noise vector at time tₖ, white, Gaussian, of zero mean and covariance matrix Rₖ=E[vₖ, vₖ^{T}] as vₖ, assuming an initial state of the system to be known, the extended Kalman filter implemented by the state observer processor 12 carries out the estimation of the state vector at each time tₖ by recurrence and more precisely by a prediction calculation and then an updating calculation.

For this purpose, the following notations are adopted:
the estimation of the state vector at time tₖ₊₁ is denoted \hat{X}_{k+1/k} after the prediction calculation but before updating by knowledge of the measurement Ymₖ₊₁,
estimation of the state vector at time tₖ₊₁ is denoted \hat{X}_{k+1/k+1} after the updating calculation,
the covariance matrix of the estimation error at time tₖ₊₁ is denoted P_{k+1/k} after the prediction calculation but before updating by knowledge of the measurement Ymₖ₊₁,
the covariance matrix of the estimation error at time tₖ₊₁ is denoted P_{k+1/k+1} after the updating calculation.

The prediction calculation is then done by means of the following equations:

\hat{X}_{k+1/k}=f(\hat{X}_{k/k},Uₖ), and

P_{k+1/k}=FₖP_{k/k}Fₖ^{T}+Qₖ, where

$${F}_{k} = F ( {\hat{X}}_{k / k} , {U}_{k} ) = \frac{\partial f ( X , {U}_{k} )}{\partial X} {\vert}_{X = {\hat{X}}_{k / k}} .$$

The updating calculation is then done by means of the following equations:

Kₖ₊₁=P_{k+1/k}Hₖ₊₁^{T}(Hₖ₊₁P_{k+1/k}Hₖ₊₁^{T}+Rₖ₊₁)⁻¹,

\hat{X}_{k+1/k+1}=\hat{X}_{k+1/k}+Kₖ₊₁(Ymₖ₊₁−h(\hat{X}_{k+1/k},Uₖ₊₁)), and

P_{k+1/k+1}=(I_{3×3}−Kₖ₊₁Hₖ₊₁)P_{k+1/k}, where

$${H}_{k + 1} = H ( {\hat{X}}_{k + 1 / k} , {U}_{k + 1} ) = \frac{\partial h ( X , {U}_{k + 1} )}{\partial X} {\vert}_{X = {\hat{X}}_{k + 1 / k}} .$$

It should be noted that, in accordance with the static gain model adopted to define the non-linearity of the system 20,

$${F}_{k} = \frac{\partial f ( X , {U}_{k} )}{\partial X} {\vert}_{X = {\hat{X}}_{k / k}} and$$

$${H}_{k + 1} = \frac{\partial h ( X , {U}_{k + 1} )}{\partial X} {\vert}_{X = {\hat{X}}_{k + 1 / k}}$$

are Jacobian matrices independent of the state vector Xₖ, which in practice simplifies implementation in the state observer processor.

For closed-loop functioning of the control system 10, the corrector 16 must also be based on a control law integrating the aforementioned model. Various types of control law exist. A regulation of the PID (standing for “proportional, integral, derivative”) type is entirely suited and is used very widely in control engineering. It is detailed below purely for illustration, knowing that other regulations can be applied in the context of the invention.

In accordance with PID regulation and the state representation model adopted in this embodiment, the corrector 16 respects the following canonical form in the Laplace domain:

$${K}_{PID} ( s ) = K ( 1 + \frac{1}{{T}_{i} s} + \frac{{T}_{d} s}{1 + \frac{{T}_{d}}{N} s} ) , where \frac{{T}_{d}}{N} , {T}_{d} ,$$

Tᵢ and K represent the gains of the regulation.

Thus, if it is wished to obtain a closed-loop transfer function for the non-linear system 20 corrected by this corrector 16, in the following form:

$$\frac{y ( s )}{u ( s )} = \frac{g}{\frac{1}{{w}_{0}^{2}} {s}^{2} + \frac{2 {ξ}_{0}}{{w}_{0}} s + 1} ,$$

where w₀ and ξ₀ and represent respectively the natural angular frequency and the damping of the expected system, the gains of the regulation take the following values:

$$\frac{{T}_{d}}{N} = \frac{1}{2 {ξ}_{0} {w}_{0}} , {T}_{i} = \frac{2 ξ}{{w}_{n}} - \frac{1}{2 {ξ}_{0} {w}_{0}} , {T}_{d} = \frac{1 / {w}_{n}}{{T}_{i}} - \frac{1}{2 {ξ}_{0} {w}_{0}} and$$

$$K = \frac{{w}_{0} {T}_{i}}{2 g {ξ}_{0}} .$$

In particular, it should be noted that the proportional gain K of the corrector 16 depends on the static gain parameter g of the non-linear system 20. However, this gain parameter g varies because of the non-linearity of the system 20 and, as we have seen, by virtue of the invention, the variations in this gain parameter can be estimated in real time by the state observer processor 12. We shall thus show that the PID regulation used by the corrector 16 can be made adaptive very simply by taking into account the gain parameter g in calculating its proportional gain K without a complex global model of the static non-linearity of the system 20 being necessary. This remains valid of course in the particular case where the static non-linearity is of the hysteresis type.

The closed-loop functioning of the control system 10 described previously will now be detailed with reference to FIG. 2.

During a first slaving step 100, the comparator 18 of the control system 10 compares a set value E(t) with the state of the system 20 known from a measurement of the output Y(t) of the system. This state for example comes from the estimation \hat{X}(t) that is made of it by the state observer processor 12 according to the measurement Ym(t). The slaving signal ε(t) is supplied at the output of the comparator 18.

Next, during a step 102, the adaptive PID corrector 16 updates its proportional gain K according to the value ĝ of the gain parameter g, this value ĝ being supplied by the state observer processor 12 according to the measurement Ym(t) and the previous control, in order to supply a new control vector U(t).

During the following step 104, this control vector is applied to the non-linear system 20. In reaction, the non-linear system 20 changes during a step 106.

Then, during a measurement step 108, the state observer processor 12 receives a new value of the measurement Ym(t) from the sensor 14. It derives from this a new estimation of the state vector (step 110), also according to the last value of the control vector, this estimation being supplied on the one hand to the comparator 18 so that it updates its knowledge of the state of the system 20 and on the other hand to the corrector 16 so that it adapts its regulation according to the new value of the gain parameter g.

Steps 100 to 110 are repeated in a loop. It should be noted that they can be implemented in the form of instructions of a computer program and be synchronized during their execution by the clock signal of a processor of the computer that executes the program.

As illustrated in FIG. 3, one application of the invention that can be envisaged concerns the observation and optionally the closed-loop control of a piezoelectric microactuator 20A in the field of microrobotics.

Such an actuator is said to have a “unimorph” structure, which is a structure commonly used in microrobotics. This means that, when it is subjected to a voltage difference at its terminals, this type of actuator is capable of producing a bending movement. By using this movement, it is possible to seize various small objects in order to perform micromanipulation tasks. A piezoelectric microactuator behaves as a non-linear system of the static-hysteresis Hammerstein type. In accordance with the invention, its control can be provided by the control system 10 described previously, in which static hysteresis is taken into account in the form of the gain parameter g integrated in the state vector estimated in real time by the state observer processor 12.

In the installation shown schematically in FIG. 3, the piezoelectric microactuator 20A is fixed at one of its ends against a support 26. The sensor 14 of the control system 10, which is precisely in this application a high-resolution laser sensor in order to be able to measure the micrometric movements of the piezoelectric microactuator 20A, is placed so that the other end of the microactuator, free and able to move in flexion, is situated in its laser emission beam.

The state observer processor 12, the corrector 16 and the comparator 18 are for example implemented in programmed form in a computer 28 that in a conventional fashion comprises at least one microprocessor, at least one memory of the RAM, ROM and/or other type, and at least one data transmission bus between the microprocessor and the memory. The computer supplies a control signal U(t), optionally amplified by an amplifier 30, to the piezoelectric microactuator 20A to which it is electrically connected.

FIG. 4 illustrates the measured static hysteresis of the piezoelectric microactuator 20A and its dependency on the frequency of the exciting control signal: depending on the value f of this frequency, 20 Hz, 300 Hz, 600 Hz or 900 Hz, it can in fact be measured experimentally and transferred onto the diagrams in FIG. 4 that the bending D of the microactuator according to the voltage U at its terminals describes four different hysteresis curves.

In accordance with the model defined previously:
the static hysteresis of the piezoelectric microactuator 20A is modeled by the static gain parameter g variable over time,
the dynamics of the piezoelectric microactuator 20A is modeled by a two-pole transfer function the Bode diagram of which is illustrated in FIG. 5.

In this FIG. 5, the curve A describes the values that can be found experimentally while the curve B results from a simulation. It will be noted that these two curves are very close over a wide range of frequencies so that the dynamic linearity model chosen can be considered to be faithful to the actual dynamics of the piezoelectric microactuator 20A.

Experimentally, for a sampling period Tₑ of 0.1 ms and regulation gains of the adaptive PID corrector 16 calculated for a zero static error, no exceeding of the set value and a rise time of 20 ms, a response of the slaved movement is obtained in accordance with the curve B of the diagram of FIG. 6, whereas the same PID corrector but not made adaptive by taking the gain parameter g into account would lead to curve A in this same figure.

In particular, exceedings of the set value are observed on curve A whereas there are none on curve B. This shows that the observation of the variations in the gain parameter g integrated in the state vector and their taking into account in the regulation improves the control performances of the hysteresis Hammerstein systems.

FIG. 7 illustrates by diagram the corresponding variations in the gain parameter g as observed by the state observer processor 12.

Finally, as illustrated in FIG. 8, another application of the invention that can be envisaged concerns the observation and closed-loop control of a robotic articulation 20B with transmission by manipulator arm cable.

The outline diagram of FIG. 8 shows this articulation 20B in the form of a pulley 32 free to rotate about an axis 34. The rotation is controlled by a motor 36 which, by means of an arm 38, a worm 40, a cable 42 and a mechanism for guidance 44 and return 46 of the cable 42, drives the rotation θₐ of the pulley 32. This movement transmission chain makes the robotic articulation with cable transmission in conformity with a system of the hysteresis Hammerstein type.

In this application, the movement measured and observed is the rotation θₐ of the pulley 32 about the axis 34. This rotation θₐ is measured by an angular sensor 48 connected to an acquisition card 50. This measure is imperfect because of the existence of the hysteresis mainly due to the rubbing of the cable 42 on the pulley 32.

The control θₘ effected by the motor 36 is itself measured by an angular coder 52 of the motor. This measurement is of good quality but the angular coder 52 is distant from the articular transmission.

The aforementioned measurements are supplied to the state observer processor 12 which, in this application also, supplies in response an estimation of the variations of the gain parameter g defined in order to take into account the hysteresis phenomenon.

As in the previous application, the state observer processor 12, the corrector 16 and the comparator 18 are for example implemented in programmed form in a computer (not illustrated) that comprises in a conventional fashion at least one microprocessor, at least one memory of the RAM, ROM and/or other type, and at least one data transmission bus between the microprocessor and the memory.

Many other applications can be envisaged, so vast is the field of automation of non-linear systems. In particular, micromanipulation has recourse to highly non-linear actuators.

It is clear that a control system such as the one described previously makes it possible to identify, by means of the state observer processor 12 associated with a sensor 14, then if applicable to take into account in the synthesis of the adaptive control law a posteriori, by means of the corrector 16, the phenomenon of static non-linearity and in particular of hysteresis existing for certain classes of non-linear systems.

This identification is very simple since it is based on the observation of a state vector that includes a static gain parameter. It can therefore be implemented in real time. However, it is precisely this simple static gain parameter observed over the course of time that precisely and exhaustively takes account of the non-linearity of the system without its being necessary first to establish a complete global model of this non-linearity.

By applying the result of this observation to a PID corrector, very commonly used in closed-loop control, in order to vary its proportional gain K, it is made adaptive and therefore efficient. The precision of the resulting control is improved.

For a system with static non-linearity of the hysteresis type, the method presented above therefore has the major advantage of not requiring any particular prior modeling of the hysteresis. This is because, usually, the form of this hysteresis depends on external and environmental parameters that are not controlled. It therefore becomes difficult to model all the possible forms of hysteresis curves and to load all these possible forms in a control system. In addition, the known strategies for modeling hysteresis are generally based on experimental tests carried on the system. However, as seen with reference to FIG. 4, hysteresis is a phenomenon which depends in particular on the amplitudes and frequencies of the exciting signals at the input of the system. This therefore assumes knowing in advance the range of amplitudes and frequencies of the signals that would be used a posteriori when the system is slaved. Conversely, the method described previously does not require any prior experimental protocols for characterizing the hysteresis phenomenon. The modeling that is done of this is a simple gain observed by a state observer, for example an extended Kalman filter.

It will also be noted that the invention is not limited to the embodiments and applications described previously. It will indeed be clear to a person skilled in the art that various modifications can be made to the embodiments and applications described above, in the light of the teaching that has just been disclosed to him.

In particular, in the embodiments and applications described above, the choice was made of a corrector of the PID type, but some may prefer to adopt other methodologies for regulating the control. The principle of modeling an observation of the non-linearity of the control system presented above remains compatible with other control laws.

Finally, in the claims that follow, the terms used must not be interpreted as limiting the claims to the embodiments disclosed in the present description but must be interpreted in order to include therein all the equivalents that the claims aim to cover because of their wording and the provision of which is within the scope of a person skilled in the art applying his general knowledge to the implementation of the teaching that has just been disclosed to him.

1-10. (canceled)

11. A device for observing a non-linear system, comprising:
at least one sensor for supplying a measurement vector each component of which is a measurable output parameter of the non-linear system;
a state observer processor that, based on a predetermined state representation of the non-linear system, is configured to supply an estimation of a state vector of the non-linear system according to the measurement vector supplied and a control vector of the non-linear system;
wherein, the predetermined state representation comprises a model of non-linearity of the system in a form of a gain parameter, and one component of the state vector is the gain parameter.

12. A device according to claim 11, wherein the state observer processor is based on a state representation comprising a non-linear part modeled by the gain parameter representing statics of the non-linear system, and a linear part modeled by a predetermined transfer function.

13. A device according to claim 11, wherein the state observer processor includes an extended Kalman filter.

14. A system for controlling a non-linear system comprising:
an observation device according to claim 11; and
a control vector corrector based on a control law comprising a gain regulated over time according to values taken by the gain parameter of the state vector.

15. A control system according to claim 14, wherein the corrector is of variable-gain PID type.

16. A control system according to claim 15, wherein the variable-gain PID corrector comprises a proportional gain defined as inversely proportional to the gain parameter of the state vector.

17. A method for observing a non-linear system comprising:
reception, by a state observer processor based on a predetermined state representation of the non-linear system, of a measurement vector each component of which is a measurable output parameter of the non-linear system;
estimation, by the state observer processor, of a state vector of the non-linear system according to the measurement vector supplied and a control vector of the non-linear system;
wherein the predetermined state representation comprises a non-linearity model of the system in a form of a gain parameter, and the estimation of the state vector comprises an estimation of the gain parameter as a component of the state vector.

18. A method for controlling a non-linear system according to claim 17, further comprising updating, by a control corrector based on a control law of the non-linear system, a gain of the control corrector according to values taken by the gain parameter of the state vector over time.

19. Application of an observation or control method according to claim 17 to observation or control of a non-linear system of static-hysteresis Hammerstein type, or a piezoelectric microactuator, or a robotic articulation with transmission by a manipulator arm cable.

20. A non-transitory computer readable medium including computer executable instructions for executing the method according to claim 17, when executed on a computer.
